(19) United States
(12) Patent Application Publication
(10) Pub. No.: US 2016/0231609 A1
(43) Pub. Date: Aug. 11, 2016

(54) DISPLAY DEVICE

(71) Applicant: Japan Display Inc., Tokyo (JP)

(72) Inventors: Kosuke DOI, Oamishirasato (JP); Toshiyuki KOSHITA, Chosei (JP)

(21) Appl. No.: 15/133,351

(22) Filed: Apr. 20, 2016

Related U.S. Application Data
(63) Continuation of application No. 13/489,559, filed on Jun. 6, 2012.

(30) Foreign Application Priority Data
Jun. 8, 2011 (JP) 2011-127837

(51) Int. Cl. G02F 1/1339; G02F 1/1335; G02F 1/1341; G02F 1/1362

(52) U.S. Cl. CPC G02F 1/13394; G02F 1/136286; G02F 1/133512; G02F 1/1341; G02F 2001/13415

(57) ABSTRACT

The present invention relates to a display device such as a liquid crystal display device including a first substrate and a second substrate with liquid crystal injected between the first and second substrates. In the display device, the second substrate includes a plurality of columnar spacers, and the first substrate has a protrusion in an area facing the top of the columnar spacer. The plurality of columnar spacers formed on the second substrate are not arranged at even intervals in the longitudinal direction of the scan line, and/or are not aligned on the line but are arranged at random.

### CLAIM OF PRIORITY

The present application claims priority from Japanese Patent Application JP2011-127837 filed on Jun. 8, 2011, the content of which is hereby incorporated by reference into this Application.

### BACKGROUND OF THE INVENTION

1. Field of the Invention

The present invention relates to a display device, and more particularly, to a display device in which a columnar spacer (a cylindrical spacer, a post-like spacer or the like) is provided between a first substrate and a 15 second substrate to keep the distance between the substrates constant.

2. Description of the Related Art

Examples of conventionally known display devices include a liquid crystal display device in which a liquid crystal is injected between a pair of substrates, an organic EL display device in which an organic light emitting device is formed between a pair of substrates, and a display device including a mechanical drive device such as MEMS. For example, in the production process of liquid crystal display devices, there is an injection sealing process to inject liquid crystal into a liquid crystal display panel. One Drop Fill (ODF) method has been increasingly used as the method for injecting liquid crystal into the liquid crystal display panel for the purpose of reducing the used amount of liquid crystal and reducing the working time (tact).

In the ODF method, the liquid crystal is not injected but is dropped on a first substrate (hereinafter referred to as a TFT substrate). Then, the TFT substrate is bonded to a second substrate (hereinafter referred to as a CF substrate). The ODF method does not have a process of injecting liquid crystal into the liquid crystal display panel, and can reduce costs and working time.

As disclosed in Japanese Unexamined Patent Application Publication No. 2005-338770, columnar spacers expressed as post-like spacers are often provided in the liquid crystal display panel to maintain the gap distance between the TFT substrate and the CF substrate.

There are two types of the columnar spacer. One is a main columnar spacer that constantly maintains the gap distance between the TFT substrate and the CF substrate. The other is a sub columnar spacer that maintains the gap distance between the TFT substrate and the CF substrate only when pressure is applied between the TFT substrate and the CF substrate.

### SUMMARY OF THE INVENTION

As described above, the display device is configured such that a liquid crystal layer, an organic light emission device layer, or an MEMS device layer is provided between a pair of substrates such as TFT substrate and CF substrate. Then, a columnar spacer is formed on the CF substrate. In the ODF method, defects often occur due to the size of the area in which the columnar spacer contacts the TFT substrate to constantly maintain the gap distance between the TFT substrate and the CF substrate.

When the contact area of the columnar spacer to the TFT substrate is large, the repulsion force between the TFT substrate and the CF substrate is strong, often causing air bubbles in the liquid crystal display panel. On the other hand, when the contact area of the columnar spacer to the TFT substrate is small, the push resistance is reduced, often causing uneven brightness and liquid crystal leakage.

Thus, in the liquid crystal display panel using the ODF method, the density of main columnar spacers is reduced so that the contact area of the main columnar spacers to the TFT substrate is smaller than that of the conventional liquid crystal display panel. Then, the reduction of the push resistance is prevented by sub columnar spacers.

In this case, when displacement occurs in the bonding process of the TFT substrate and the CF substrate, the low density contact area of the main columnar spacers to the TFT substrate varies, causing uneven brightness and liquid crystal leakage due to the reduction in the push resistance. In the ODF method, the variability of the contact area of the main columnar spacers to the TFT substrate is large. As a result, the allowance of the bonding margin is reduced.

The present invention has been made to solve the above problems of the related art. An object of the present invention is to provide a technology that can reduce the variability of the area in which the top of columnar spacers contacts a first substrate bonded to a second substrate in a display device, such as a liquid crystal display device in which liquid crystal is injected between the substrates or an organic EL display device having a gap between the substrates, when displacement occurs in the bonding process of the first and second substrates.

Other objects, advantages and novel features of the present invention will be apparent from the following detailed description when read in conjunction with the appended claims and attached drawing.

Typical aspects in plurality of the inventions disclosed in the present application will be described in brief as follows.

(1) There is provided a display device including a first substrate and a second substrate. The second substrate has a plurality of columnar spacers. The first substrate has a protrusion in an area facing the top of each columnar spacer. The first substrate has a scan line. The plurality of columnar spacers formed on the second substrate are not arranged at even intervals in the longitudinal direction of the scan line and/or are not aligned on the line but are arranged at random.
(2) There is provided a display device including a first substrate and a second substrate. The second substrate includes a plurality of columnar spacers. The first substrate has a protrusion in an area facing the top of the columnar spacer. The first substrate has a scan line. When displacement does not occur in the bonding process of the first and second substrates, some columnar spacers of the plurality of columnar spacers formed on the second substrate do not face the protrusion formed on the first substrate in the entire area of the top of each of these columnar spacers, but face the protrusion formed on the first substrate in a portion of the area of the top thereof.
(3) There is provided a display device including a first substrate and a second substrate. The second substrate includes a plurality of columnar spacers. The first substrate has a protrusion in an area facing the top of the columnar spacer. The first substrate has a scan line. When displacement does not occur in the bonding process of the first and second substrates, each columnar spacer of the plurality of columnar spacers formed on the second substrate does not face the protrusion formed on the first substrate in the entire area of the top of the columnar spacer, but faces the protrusion formed on the first substrate in a portion of the area of the top of the columnar spacer.
(4) The display device described in any one of (1) to (3), the protrusion facing the top of the columnar spacer is formed on the scan line of the first substrate.
(5) The display device described in any one of (1) to (3), the first substrate has a mount formed in the protrusion facing the top of the columnar spacer.
(6) The display device described in (4) or (5), a liquid crystal is injected between the first and second substrates. The first substrate has an oriented film on the surface on the liquid crystal side. The layer of the mount is provided between the first substrate and the oriented film.
(7) The display device described in any one of (1) to (6), the top of the columnar spacer contacts the protrusion.
(8) There is provided a display device including a first substrate and a second substrate. The second substrate includes a plurality of columnar spacers. The first substrate has protrusions in areas facing the tops of the columnar spacers. A line connecting the centers of two adjacent columnar spacers of the plurality of columnar spacers, and a line connecting the centers of the two protrusions corresponding to the two adjacent columnar spacers are not parallel.
(9) There is provided a display device including a first substrate, and a second substrate that is formed on the first substrate with a constant gap. The display device has an internal structure layer interposed between the first and second substrates, such as a liquid crystal layer, an organic light emitting device layer, or an MEMS device layer. The second substrate includes a plurality of columnar spacers. The first substrate has protrusions in areas facing the tops of the columnar spacers. The first substrate has a scan line. The plurality of columnar spacers formed on the second substrate are not arranged at even intervals and arranged unequally in the longitudinal direction of the scan line, and/or are not aligned on the line and arranged at random.

### BRIEF DESCRIPTION OF THE DRAWINGS

FIG. 1 is a top view of the electrode structure of a liquid crystal display panel according to an embodiment of the present invention;

FIG. 2 is a cross-sectional view taken along line A-A′ of FIG. 1;

FIG. 3 is a view showing the placement of columnar spacers of the liquid crystal display panel according to the embodiment of the present invention;

FIGS. 4A and 4B are schematic views showing the variability of the contact areas of the columnar spacers to the TFT substrate when displacement occurs in the bonding process of the TFT substrate and the CF substrate in the liquid crystal display panel according to the embodiment of the present invention;

FIG. 5 is a schematic cross-sectional view showing an part of the cross section structure of a liquid crystal display panel of a modification of the embodiment of the present invention;

FIG. 6 is a view showing the configuration of a pixel of the liquid crystal display panel shown in FIG. 5;

FIG. 7 is a view showing the placement of columnar spacers of a conventional liquid crystal display panel; and

FIGS. 8A and 8B are schematic views showing the variability of the contact areas of the columnar spacers to the TFT substrate when displacement occurs in the bonding process of the TFT substrate and the CF substrate in the conventional liquid crystal display panel.

### DETAILED DESCRIPTION OF THE INVENTION

Hereinafter, an embodiment of the present invention will be described in detail with reference to the accompanying drawings.

It is to be noted that components having the same function are denoted by the same reference symbols throughout the drawings for describing the embodiment, and the repetitive description thereof is omitted. The following embodiment is not intended to limit interpretation of the scope of the claims.

### First Embodiment

A liquid crystal display device according to a first embodiment includes a so-called In-Plane-Switching (IPS) liquid crystal display panel that drives liquid crystal molecules by applying an electric field between a pixel electrode and a counter electrode formed in one of a pair of glass substrates.

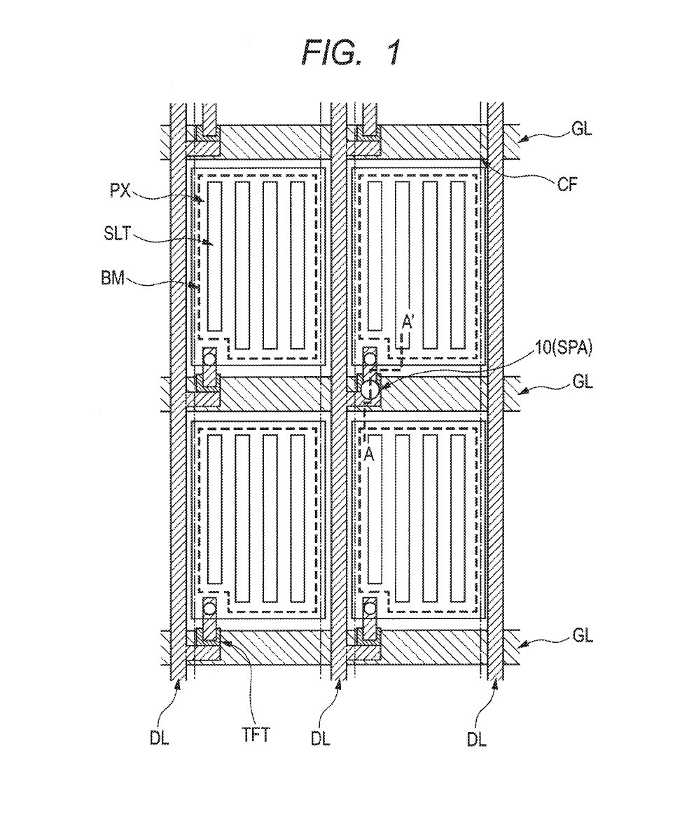

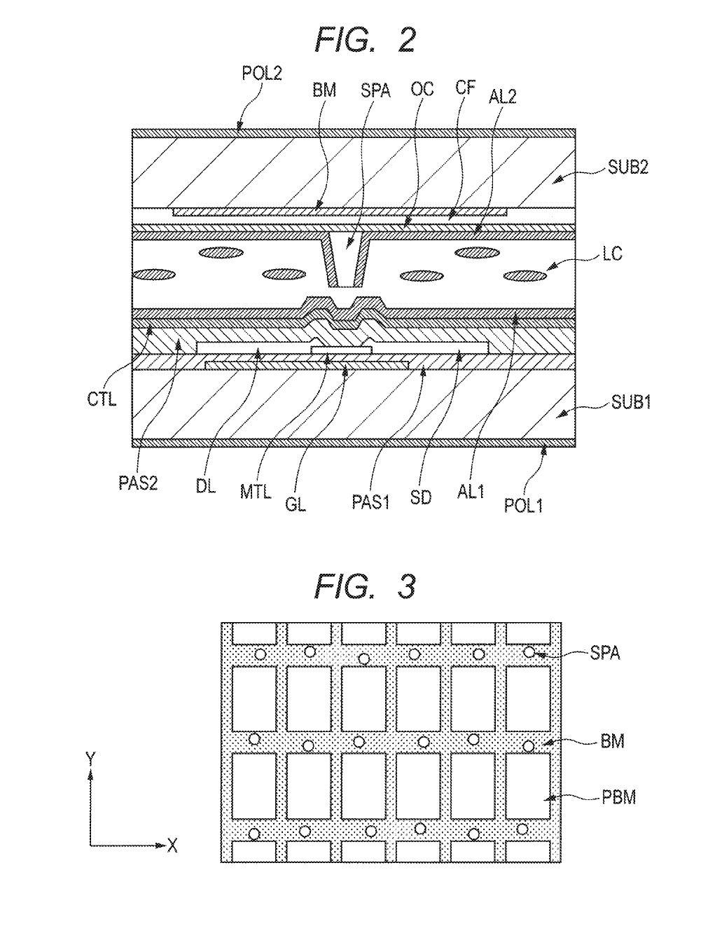

FIG. 1 is a top view of the electrode structure of a liquid crystal display panel according to an embodiment of the present invention. FIG. 2 is a cross-sectional view taken along line A-A′ of FIG. 1.

In the liquid crystal display panel according to this embodiment, a TFT substrate (a first substrate according to the present invention) and a CF substrate (a second substrate according to the present invention) are provided with a liquid crystal layer (LC) sandwiched between the two substrates.

As shown in FIG. 2, the TFT substrate has a transparent substrate (for example, a glass substrate) (SUB1). On the liquid crystal layer side of the transparent substrate (SUB1), there are formed a scan line (also called a gate line) (GL), a gate insulating film (PAS1), an a-Si semiconductor layer (MTL), an image line (also called a source line or drain line) (DL), an electrode (a drain electrode or source electrode) (SD) that is connected to a pixel electrode, an inter-layer insulating film (PAS2), a counter electrode (CTL) for generating an electric field between the pixel electrode and the counter electrode, and an oriented film (AL1) in the order from the transparent substrate (SUB1) to the liquid crystal layer (LC). Note that a polarization plate (POL1) is formed on the outside of the transparent substrate (SUB1). Although not shown in FIG. 2, the insulating film and the pixel electrode are formed on the counter electrode (CTL). The pixel electrode is connected to the electrode (SD) through a contact hole provided on the inter-layer insulating film (PAS2) and also on the insulating film. Further, the TFT substrate and the CF substrate are fixed with a predetermined distance apart from each other to inject a liquid crystal between the two substrates. The fixation is performed by adhesion with a resin sealing agent provided in the periphery of the liquid crystal display panel.

The CF substrate includes a transparent substrate (for example, a glass substrate) (SUB2). On the liquid crystal layer side of the transparent substrate (SUB2), there are formed a light shielding film (BM), color filters (CF) of red, green, and blue, a flattening film (OC), and an oriented film (AL2) in this order from the transparent substrate (SUB2) to the liquid crystal layer (LC). Further, a polarization film (POL2) is formed on the outside of the transparent substrate (SUB2). Note that in the liquid crystal display device according to this embodiment, the main surface side of the transparent substrate (SUB2) is the side to be observed.

In this embodiment, the counter electrode (CTL) is formed flat, and a plurality of slits (SLT) are formed in the pixel electrode (PX) provided between the counter electrode and the liquid crystal layer.

In the liquid crystal display device according to this embodiment, the pixel electrode (PX) and the counter electrode (CTL) are laminated with the inter-layer insulating film interposed therebetween. Arch shaped electric field lines formed between the pixel electrode (PX) and the counter electrode (CT) are distributed so as to pass through the liquid crystal layer (LC). In this way, orientation of the liquid crystal display layer (LC) is changed.

The pixel electrode (PX) and the counter electrode (CTL) are formed from transparent conductive film such as Indium Tin Oxide (ITO). Further, the pixel electrode (PX) and the counter electrode (CTL) overlap with the inter-layer insulating film interposed therebetween to retain the capacity. However, the placement of the pixel electrode and the counter electrode is not limited to this example. It is possible to place the pixel electrode and the counter electrode through the inter-layer insulating film (PAS2) or through the gate insulating film. Further, it is also possible that the positions of the pixel electrode and the counter electrode are reversed, and that the pixel electrode is made flat with slits formed in the counter electrode. Note that in this embodiment, the inter-layer insulating film (PAS2) is assumed to be an organic film. However, the material of the inter-layer insulating film (PAS2) can be changed from organic film to inorganic film in the use of the various configurations described above.

As shown in FIG. 1, one sub-pixel is formed in a rectangular area surrounded by scan lines (GL) and image lines (DL). The area in which the sub-pixel is formed is shielded from light by the light shielding film (BM) on the side of the CF substrate (SUB2). Thus, the area that actually functions as an area in which one sub-pixel is formed is an opening (represented by a heavy broken line in FIG. 1) of light shielding film (BM). Further, in FIG. 1, TFT represents a thin film transistor constituting an active element.

In the transparent substrate (SUB2), a columnar spacer (SPA) is formed in the position 10 shown in FIG. 1, to keep the gap constant between a pair of transparent substrates (SUB1, SUB2). The columnar spacer (SPA) is formed in the position in which the thin film transistor (TFT) is formed on the side of the TFT substrate (SUB1) as shown in FIG. 2.

The columnar spacer (SPA) is formed from a photosensitive resin on the light shielding film (BM) of the transparent substrate (SUB2). Note that in the actual product, a plurality of columnar spacers (SPA) are formed on the light shielding film (BM).

Further, the a-Si semiconductor layer (MTL) of TFT is formed on the scan line (GL) in the area in which the top of the columnar spacer (SPA) contacts the TFT substrate (SUB1). In other words, a mount for the columnar spacer is formed from the image line (DL), the electrode (SD) connected to the pixel electrode, and the a-Si semiconductor layer located between the image line (DL) and the electrode (SD). Note that the area with which the top of the columnar spacer comes into contact may be formed on the scan line (GL), which is separated from the TFT formation area. In this case, it is also possible to provide a metal film of aluminum (Al) or other materials, or a mount formed from an amorphous silicon layer in the area with which the top of the columnar spacer comes into contact.

The columnar spacer (SPA) shown in FIG. 1 is a main columnar spacer constantly maintains the gap distance between the TFT substrate and the CF substrate.

### Problems of the Related Art

FIG. 7 is a view showing the placement of columnar spacers of a conventional liquid crystal display panel.

FIG. 7 is a view of the CF substrate seen from the liquid crystal (LC) side. In FIG. 7, the color filters (CF) of red, green, and blue, the flattening film (OC), and the oriented film (AL2) are omitted, except the light shielding film (BM) and the columnar spacers (SPA).

In FIG. 7, PBM represents openings formed in the light shielding film (BM). Each opening corresponds to each sub-pixel. Further, in FIG. 7, the X direction is the longitudinal direction of the scan line (GL) and the Y direction is the direction orthogonal to the scan line (GL) (namely, the longitudinal direction of the image line (DL)).

In the conventional liquid crystal display panel, as shown in FIG. 7, the columnar spacers (SPA) are regularly aligned in the x and y directions on the flattening film (OC) formed on the light shielding film (BM).

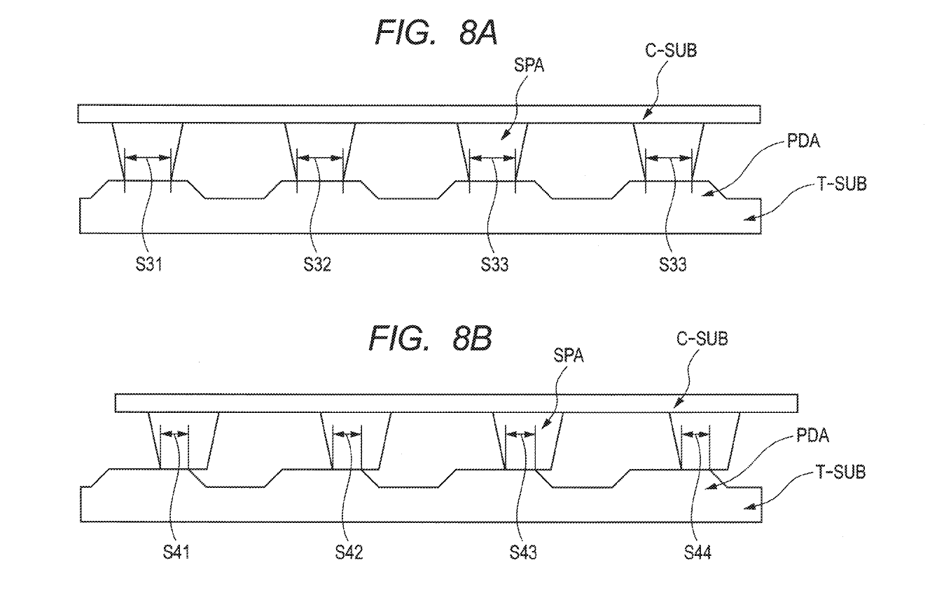

FIGS. 8A and 8B are schematic views illustrating the variability of the areas in which the columnar spacers contact the TFT substrate when displacement occurs in the bonding process of the TFT substrate and the CF substrate. In FIGS. 8A and 8B, C-SUB represents the CF substrate, in which the transparent substrate (SUB2), the light shielding film (BM), the color filters (CF) of red, green, and blue, the flattening film (OC), and the oriented film (AL2) are omitted, except the columnar spacers (SPA).

Further, T-SUB represents the TFT substrate, in which the transparent substrate (SUB1), the scan line (GL), the counter electrode (CT), the image line (DL), the thin film transistor (TFT), the inter-layer insulating films (PAS1, PAS2), the pixel electrode (PX), and the oriented film (AL1) are omitted, except the protrusions (PDA) that the columnar spacers (SPA) typically abut. Each protrusion corresponds to the protraction projecting from the mount shown in FIG. 2.

FIG. 8A shows the case in which displacement does not occur in the bonding process of the TFT substrate (T-SUB) and the CF substrate (C-SUB). FIG. 8B shows the case in which displacement occurs in the bonding process of the TFT substrate (T-SUB) and the CF substrate (C-SUB).

In the conventional liquid crystal display panel, the columnar spacers (SPA) are regularly aligned. When displacement does not occur in the bonding process of the TFT substrate (T-SUB) and the CF substrate (C-SUB), the contact area in which the top of the columnar spacers (SPA) contacts the protrusion (PDA) formed on the TFT substrate (T-TFT) is the sum of the effective contact areas of S31, S32, S33, and S34, namely, S31+S32+S33+S34.

In the conventional liquid crystal display panel, when displacement occurs in the bonding process of the TFT substrate (T-SUB) and the CF substrate (C-SUB), the contact area in which the top of the columnar spacers (SPA) contacts the protrusion (PDA) is changed to the sum of the effective contact areas of S41, S42, S43, and S44, namely, S41+S42+S43+S44. At this time, the variability of the effective contact areas can be expressed by the following equation (1):

(S41+S42+S43+S44)×100/(S31+S32+S33+S34) (1)

FIG. 3 is a view schematically showing the placement of the columnar spacers of the liquid crystal display panel according to this embodiment. FIG. 3 is a view of the CF substrate seen from the liquid crystal (LC) side. In FIG. 3, the color filters (CF) of red, green, and blue, the flattening film (OC), and the oriented film (AL2) are omitted, except the light shielding film (BM) and the columnar spacers (SPA).

In FIG. 3, PBM represents openings formed in the light shielding film (BM) as similarly shown in FIG. 7. Each opening corresponds to each sub-pixel. Further, in FIG. 3, the X direction is the longitudinal direction of the scan line (GL), and the Y direction is the direction orthogonal to the scan line (GL). In other words, the y direction is the longitudinal direction of the image line (DL).

In the liquid crystal display panel according to this embodiment, as shown in FIG. 3, the columnar spacers (SPA) are not regularly aligned in the X and Y directions on the flattening film (OC) formed on the light shielding film (BM). The columnar spacers (SPA) are randomly arranged by shifting from their regularly arranging positions in the X and Y directions.

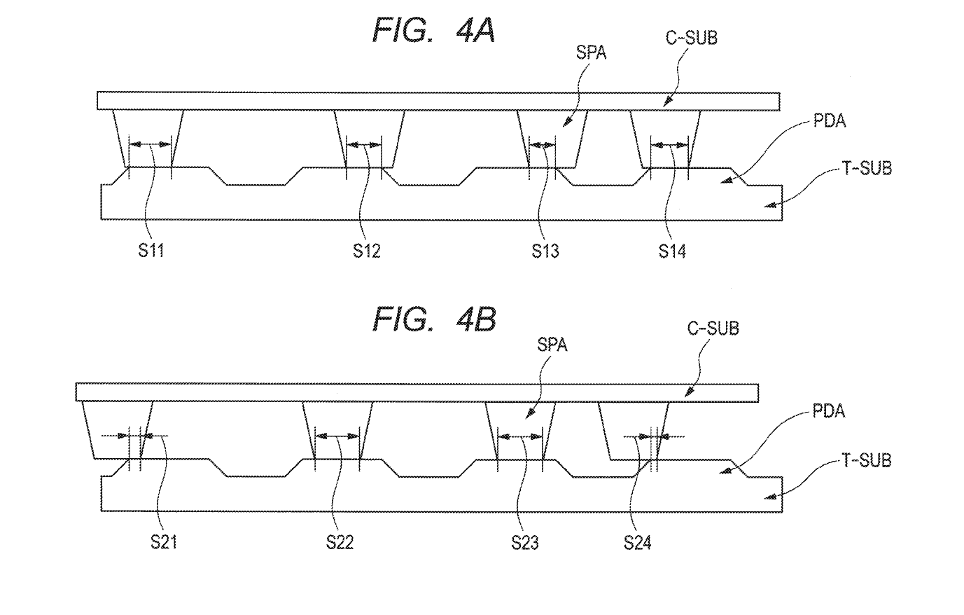

Thus, as shown in FIG. 4, described below, this embodiment is designed such that the entire area of the top of the columnar spacer (SPA) does not contact the protrusion (PDA) formed on the TFT substrate (T-SUB), but a portion of the area of the top of the columnar spacer (SPA) contacts the protrusion (PDA).

In the above description, the protrusion (PDA) formed on the TFT substrate (T-SUB) is formed from the mount. However, the protrusion (PDA) may be formed, for example, from an intersection of signal lines. Further, the random arrangement means that the line connecting the points where the columnar spacers are formed is not parallel to the longitudinal direction of the scan line or image line, or is not parallel to the line connecting the points where the mounts are formed. In other words, this means that at least the line connecting the centers of two adjacent columnar spacers and the line connecting the centers of the two protrusions corresponding to the two adjacent columnar spacers are not parallel to each other.

It is also possible that several columnar spacers are randomly arranged and placed repeatedly.

In this embodiment, one columnar spacer is formed in each sub-pixel. However, the effect of the present invention can be obtained when one columnar spacer is formed for a plurality of sub-pixels. Further, for example, the columnar spacer of a blue sub-pixel is defined as a main spacer, and the columnar spacer of a sub-pixel of a color other than blue is defined as a sub spacer. In this case, the main spacer typically contacts the TFT substrate and the sub spacer does not contact the TFT substrate. The number of colors of sub-pixels in which the main and sub spacers are placed is not limited. It is possible that both or either of the main spacers and the sub spacers are arranged at random.

FIGS. 4A and 4B are schematic views illustrating the variability of the areas in which the columnar spacers contact the TFT substrate when displacement occurs in the bonding process of the TFT substrate and the CF substrate. In FIGS. 4A and 4B, C-SUB represents the CF substrate described in FIGS. 8A and 8B. Also, T-SUB represents the TFT substrate described in FIGS. 8A and 8B. Further, PDA represents the protrusions that the columnar spacers (SPA) typically abut. The protrusion corresponds to the protrusion projecting from the mount that is shown in FIG. 2.

FIG. 4A shows the case in which displacement does not occur in the bonding process of the TFT substrate (T-SUB) and the CF substrate (C-SUB). FIG. 4B shows the case in which displacement occurs in the bonding process of the TFT substrate (T-SUB) and the CF substrate (C-SUB).

In the liquid crystal display panel according to this embodiment, when displacement does not occur in the bonding process of the TFT substrate (T-SUB) and the CF substrate (C-SUB), the contact area in which the top of the columnar spacer (SPA) contacts the protrusion (PDA) formed on the TFT substrate (T-TFT) is the sum of the effective contact areas of S11, S12, S13, and S14, namely, S11+S12+S13+S14.

In the liquid crystal display panel according to this embodiment, when displacement occurs in the bonding process of the TFT substrate (T-SUB) and the CF substrate (C-SUB), the contact area in which the top of the columnar spacer (SPA) contacts the protrusion (PDA) is changed to the sum of the effective contact areas of S21, S22, S23, and S24, namely, S21+S22+S23+S24. At this time, the variability of the effective contact areas can be expressed by the following equation (2):

(S21+S22+S23+S24)×100/(S11+S12+S13+S14) (2)

In the liquid crystal display panel according to this embodiment, when displacement does not occur in the bonding process of the TFT substrate (T-SUB) and the CF substrate (C-SUB), the contact area in which the top of the columnar spacer (SPA) contacts the protrusion (PDA) formed on the TFT substrate (T-TFT) is smaller than the contact area in the conventional liquid crystal display panel.

However, the variability of the effective contact areas of the liquid crystal display panel according to this embodiment, which is given by the equation (2), can be reduced to a level lower than the variability of the effective contact areas of the conventional liquid crystal display panel that is given by the equation (1).

For example, when the displacement in the bonding process of the TFT substrate (T-SUB) and the CF substrate (C-SUB) is within the specifications (±3 μm), the variability of the contact area in which the top of the columnar spacer (SPA) contacts the protrusion formed on the TFT substrate (T-TFT) is 93.86% in the conventional liquid crystal display panel. Thus, the variability is reduced by about 6.14%. On the other hand, the variability of the contact area in the liquid crystal display panel according to this embodiment is 96.42%. Thus, the variability is reduced by about 3.58%. In this embodiment, when the displacement in the bonding process of the TFT substrate (T-SUB) and the CF substrate (C-SUB) is within the specifications (±3 μm), the variability of the contact area in which the top of the columnar spacer (SPA) contacts the TFT substrate (T-TFT) can be reduced to a level lower than the variability in the conventional liquid crystal display panel. Note that in the above description, it is assumed that the top of the columnar spacer contacts the protrusion. However, the top of the columnar spacer is not typically contact the protrusion according to the circumstances. For example, the top of the columnar spacer may not contact the protrusion when any force is not applied. For this reason, the contact area is the area in which the top of the columnar spacer is likely to contact the protrusion, namely, the area of the top of the columnar spacer facing the protrusion.

FIG. 8B shows the conventional liquid crystal display panel in which displacement occurs in the bonding process of the TFT substrate (T-SUB) and the CF substrate (C-SUB). FIG. 4A shows the liquid crystal display panel according to this embodiment, in which displacement does not occur in the bonding process of the TFT substrate (T-SUB) and the CF substrate (C-SUB). The states shown in FIG. 8B and FIG. 4A seem to be the same.

However, in the conventional liquid crystal display panel, as shown in FIG. 7, the columnar spacers (SPA) are regularly aligned in the X and Y directions. When displacement occurs in the bonding process of the TFT substrate (T-SUB) and the CF substrate (C-SUB), the displacement direction (or moving direction) from the center of the protrusion (PDA) formed on the TFT substrate (T-TFT) to the center of the columnar spacer (SPA) is the same for all the columnar spacers (SPA).

On the other hand, in the liquid crystal display panel according to this embodiment, the columnar spacers (SPA) are not regularly aligned in the X and Y directions and are randomly arranged by shifting from their regularly arranging positions in the x and y directions. For this reason, in the liquid crystal display panel according to this embodiment, when displacement occurs in the bonding process of the TFT substrate (T-SUB) and the CF substrate (C-SUB), the displacement direction (or moving direction) from the center of the protrusion (PDA) formed on the TFT substrate (T-TFT) to the columnar spacer is random for each columnar spacer (SPA).

Note that in FIGS. 3 and 7, the cross-sectional planar shape of the columnar spacer (SPA) has a circular shape. However, the cross-sectional planar shape of the columnar spacer is not limited to the circular shape, and may be an elliptical shape, or polygonal shape such as a triangular shape or a quadrangular shape. Also, the shape of the columnar spacer in the normal direction to the substrate is not limited to the columnar or cylindrical shape, and may be a hemispherical shape, a semi-oval spherical shape, a spindle shape or a truncated pyramidal shape.

Further, in FIGS. 4A and 4B, with respect to all the columnar spacers (SPA), a portion of the area of the top of each columnar spacer (SPA) contacts the protrusion (PDA) formed on the TFT substrate (T-TFT). However, it is also possible that a portion of the area of the top of two or more columnar spacers (SPA) of a plurality of columnar spacers (SPA) contacts the protrusion (PDA) formed on the TFT substrate (T-TFT).

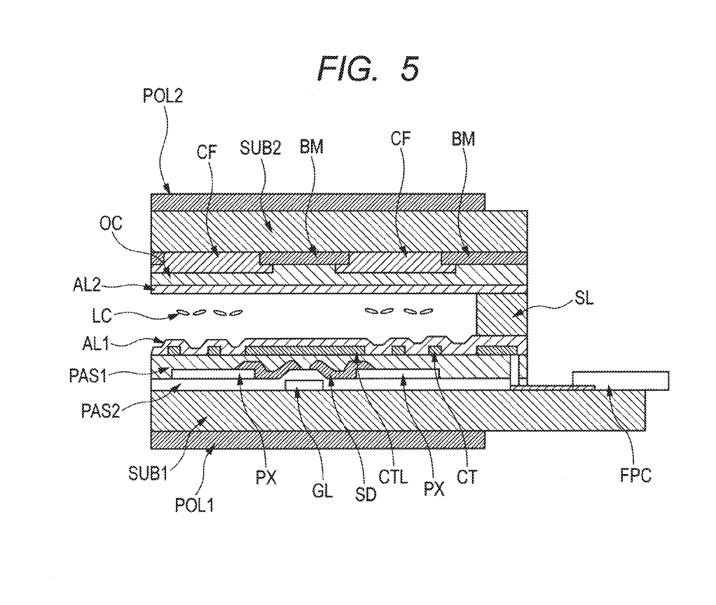

FIG. 5 is a schematic cross-sectional view showing a part of the cross section structure of a liquid crystal display panel of a modification of the embodiment of the present invention.

The liquid crystal display panel shown in FIG. 5 includes a TFT substrate and a CF substrate with a liquid crystal layer (LC) sandwiched therebetween. As shown in FIG. 5, the TFT substrate includes a transparent substrate (for example, a glass substrate) (SUB1). On the liquid crystal layer side of the transparent substrate (SUB1), there are formed a scan lines (also called a gate line) (GL), a gate insulating film (PAS2), an image line (not shown), a pixel electrode (PX), an electrode (a drain electrode or a source electrode) (SD) connected to the pixel electrode (PX), an inter-layer insulating film (PAS1), a counter electrode (CT, CTL), and an oriented film (AL1) in this order from the transparent substrate (SUB1) to the liquid crystal layer (LC). Further, a polarization plate (POL1) is provided on the outside of the transparent substrate (SUB1).

On the liquid crystal layer side of the transparent substrate (SUB2), there are formed a light shielding film (BM), color filters (CF) of red, green, and blue, a flattening film (OC), and an orientation film (AL2) in this order from the transparent substrate (SUB2) to the liquid crystal layer (LC). Further, a polarization film (POL2) is provided on the outside of the transparent substrate (SUB2). In FIG. 5, SL represents a sealing material, and FPC represents a flexible wiring substrate.

Note that in the liquid crystal display panel shown in FIG. 5, the pixel electrode (PX) is formed flat, and the counter electrode (CT, CTL) has a plurality of slits.

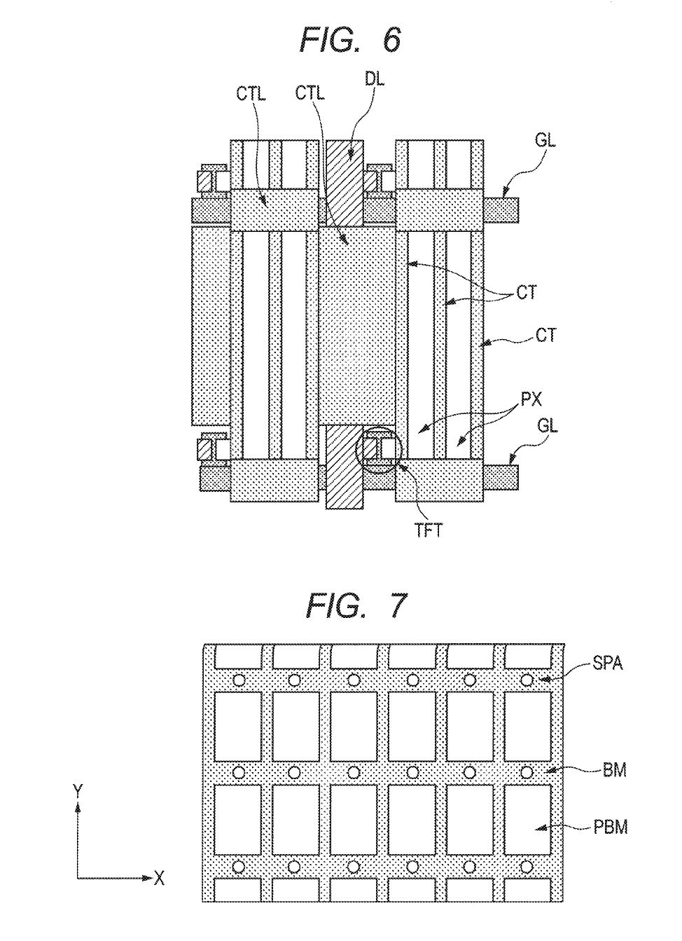

FIG. 6 is a view of the structure of a pixel of the liquid crystal display panel shown in FIG. 5.

In FIG. 6, DL represents the image line and GL represents the scan line. The scan line (GL) and the image line (DL) are arranged so as to intersect each other.

A thin film transistor (TFT) is provided at the intersection of the scan line (GL) and the image line (DL). The gate electrode of the thin film transistor (TFT) is connected to the scan line (GL), and the drain electrode (or source electrode) of the thin film transistor (TFT) is connected to the image line (DL).

A counter voltage is supplied to the counter electrode (CT, CTL). For example, when the AC drive method of the liquid crystal display panel (LCD) is the common symmetry method such as the dot inversion method, a constant potential (such as ground potential GND) is supplied to the counter electrode (CT, CTL).

Further, in the above description, the embodiment of the present invention is applied to the IPS-type liquid crystal display device. However, the present invention is not limited to this type of display device. For example, the present invention can also be applied to other types of liquid crystal display devices, such as twisted nematic (TN) type, electrically controlled birefringence (ECB) type or vertically aligned (VA) type. However, when the present invention is applied to these liquid crystal display devices, the counter electrode (CT) is provided on the side of the CF substrate (SUB2).

Note that in the above description, the color filters are provided in the substrate facing the TFT substrate, but the color filters may be provided on the side of the TFT substrate. In this case, the CF substrate may also be referred to as the counter substrate. Further, the light shielding film formed on the CF substrate is arranged in matrix, but is not particularly limited to this arrangement. It is also possible that the light shielding film can be formed in a strip shape only in the direction parallel to the image line. It goes without saying that the columnar spacer can be provided not only on the TFT and the scan line but also on the image line. Further, in this embodiment, it is assumed that the mount is provided on the TFT substrate corresponding to the columnar spacer. However, as described above, it is also possible to use the protrusion formed from the step at the intersection of the signal lines. In addition, the areas themselves in which the lines, such as the scan lines and the image lines, are formed are raised higher than other areas, so that the protrusions can be formed by using these raised areas.

The embodiment described above relates to a liquid crystal display device. However, the present invention can also be applied to an organic EL display device in which a TFT substrate having an organic light emitting device is bonded to the other substrate (counter substrate) with a predetermined distance therebetween, and to a display device in which a first substrate having a mechanical drive device such as MEMS is bonded to a second substrate with a gap so that gas or liquid is injected into the gap between the first and second substrates.

The present invention made by the present inventors has been described in detail based on the embodiment. However, it is to be understood that the present invention is not limited to such an embodiment, and various modifications can be made within the scope of the present invention.

What is claimed is:

1. A display device comprising:
a first substrate,
image lines arranged in a first direction on the first substrate,
scan lines arranged in a second direction on the first substrate,
a first pixel, a second pixel adjacent to the first pixel in the first direction, a third pixel adjacent to the first pixel in the second direction, and a fourth pixel adjacent to the third pixel in the first direction and adjacent to the second pixel in the second direction,
a second substrate opposing to the first substrate, light shields overlapped the scan lines and the image lines, and
spacers arranged between the first substrate and the second substrate, and overlapped the light shield films,
wherein the spacers having a first spacer adjacent to the first pixel, a second spacer adjacent to the second pixel, a third spacer adjacent to the third pixel and a fourth spacer adjacent to the fourth pixel,
wherein a first line connecting a center of the first spacer and a center of the second spacer, a second line connecting a center of the third spacer and a center of the fourth spacer, a third line connecting the center of the first spacer and the center of the third spacer, and a fourth line connecting the center of the second spacer and the center of the fourth spacer,
wherein a direction of the first line and a direction of the second line are different from the first direction, and
a direction of the third line and a direction of the fourth line are different from the second direction.

2. The display device according to claim 1,
wherein the spacers are sub-spacers which maintain the gap distance between the first substrate and the second substrate only when receiving stress.

3. The display device according to claim 1,
wherein the first spacer is arranged outside of the first pixel, the second spacer is arranged outside of the second pixel, the third spacer is arranged outside of the third pixel and the fourth spacer is arranged outside of the fourth pixel.

4. The display device according to claim 1,
wherein the first line, the second line, the third line, and the fourth line are not orthogonal, respectively.

5. A display device comprising:
a first substrate,
a scan line on the first substrate,
a second substrate opposing to the first substrate,
a light shield film on the second substrate, wherein the first light shield film is overlapped the scan line, and
spacers on the second substrate, wherein the spacers are overlapped the light shield film,
wherein spacers having a first spacer, a second spacer, a third spacer and a fourth spacer,
wherein a first portion of the first spacer, a second portion of the second spacer, a third portion of the third spacer and a fourth portion of the fourth spacer are contact with the first substrate, and
wherein each area in contact with the first substrate of each of the portions is different, respectively.

6. The display device according to claim 5, further comprising,
protrusions on the first substrate,
wherein the first portion, the second portion, the third portion and the fourth portion are contact with the protrusions.

7. The display device according to claim 6,
wherein the protrusions formed by a semiconductor layer.

8. The display device according to claim 6, further comprising, an image line intersecting with the scan line,
wherein the protrusions formed by intersection of the scan line and the image line.

9. A display device comprising:
a first substrate,
image lines arranged in a first direction on the first substrate,
scan lines arranged in a second direction on the first substrate,
a second substrate opposing to the first substrate,
light shield films overlapped the scan lines and the image lines, and
spacers between the first substrate and the second substrate, and overlapped the light shield films,
wherein the light shield films having a first opening, a second opening adjacent to the first opening in the first direction, a third opening adjacent to the first opening in the second direction and a forth opening adjacent to the second opening in the second direction and the third opening in the first direction,
wherein the spacers having a first spacer which arranged between the first opening and the third opening and a second spacer which arranged between the second opening and the fourth opening,
wherein a center line of the light shield film arranged between the first opening and the third opening and between the second opening and the fourth opening is not overlapped a center of the first spacer and a center of the second spacer,
wherein a first straight line connecting a center of the first opening and a center of the third opening is not overlapped a center of the first spacer, and
wherein a second straight line connecting a center of the second opening and a center of the fourth opening is not overlapped a center of the second spacer.

10. The display device according to claim 9,
wherein the first straight line and the second straight line are parallel to the second direction.

11. The display device according to claim 9,
wherein the center line of the light shield film is parallel to the first direction.

12. The display device according to claim 9,
wherein an intersection of the first straight line and the center line of the light shield film is not overlapped the center of the first spacer, and
wherein an intersection of the second straight line and the center line of the light shield film is not overlapped the center of the second spacer.

13. The display device according to claim 9,
wherein the first spacer Is arranged outside of the first opening and the third opening, and the second spacer is arranged outside of the second opening and the fourth opening.
